(19) United States
(12) Patent Application Publication
(10) Pub. No.: US 2026/0284765 A1
(43) Pub. Date: Sep. 24, 2026

(54) ELECTROCHEMICAL MACHINING APPARATUSES FOR THIN METAL STRIPS AND MACHINING METHODS THEREOF

(71) Applicant: TAIYUAN UNIVERSITY OF TECHNOLOGY, Taiyuan (CN)

(72) Inventors: Jing WANG, Taiyuan (CN); Tao WANG, Taiyuan (CN); Zhongkai REN, Taiyuan (CN); Wenyun LI, Taiyuan (CN)

(73) Assignee: TAIYUAN UNIVERSITY OF TECHNOLOGY, Taiyuan (CN)

(21) Appl. No.: 19/375,489

(22) Filed: Oct. 31, 2025

(30) Foreign Application Priority Data
Mar. 20, 2025 (CN) 202510329664.0

(51) Int. Cl. B23H 9/02; B23H 3/10; B23H 11/00

(52) U.S. Cl. CPC B23H 9/02; B23H 3/10; B23H 11/00; B23H 2400/00

(57) ABSTRACT

Provided is an electrochemical machining apparatus for thin metal strips and a machining method. The apparatus includes an upper fixture, a lower fixture, a pressing part, a conveying mechanism, a power supply, a thickness gauge, a controller, a high-transmittance optical glass, and a high-speed camera. The upper fixture is provided with a through slot and an electrolyte channel, the electrolyte channel is arranged around the through slot, and a surface of the lower fixture close to the upper fixture is provided with a groove, a machining area is formed between the groove and a lower surface of the upper fixture, the machining area is communicated with both the electrolyte channel and the through slot, and the machining area is configured to accommodate a thin strip material; the pressing part is embedded in the through slot; and the high-transmittance optical glass is embedded in the upper fixture.

### CROSS-REFERENCE TO RELATED APPLICATIONS

This application claims priority to Chinese Patent Application No. 202510329664.0, filed on March 20, 2025, the entire contents of which are hereby incorporated by reference.

### TECHNICAL FIELD

The present disclosure generally relates to the field of electrochemical machining, and in particular to an electrochemical machining apparatus for thin metal strips and an electrochemical machining method for thin metal strips.

### BACKGROUND

Currently, precision ultra-thin strips have excellent characteristics such as high temperature resistance, corrosion resistance, high fatigue strength, and high flatness, and have become manufacturing materials for key components in fields such as aerospace, national defense and military industry, instrumentation, and medical devices. For example, precision ultra-thin stainless steel strips are used for artificial satellites, screen substrates of flexible displays, key domes of electronic components, vascular stents, etc. However, a thickness of precision ultra-thin strips is below 0.1 mm, which has high requirements for stability, manufacturing accuracy, and forming quality, causing manufacturing processes and equipment for precision ultra-thin strips complex and the processing difficulty high.

Rolling processes are usually configured to prepare the precision ultra-thin strips, but prepared ultra-thin strips have residual stress on surfaces. At the same time, the work rolls are in a high-speed, high-temperature, and high-load operating environment for a long time, causing damage and fatigue on the roll surface, which affects the forming quality and yield of the precision ultra-thin strips. Therefore, existing ultra-thin strip processing processes cannot solve problems such as residual stress on the surface of precision ultra-thin strips and easy damage to the work roll surface. In addition, in electrochemical machining, it is difficult to fix thin strip materials on the apparatus, and during the machining process, the thin strip materials are prone to deformation due to flushing of the electrolyte, resulting in low machining accuracy.

### SUMMARY

One or more embodiments of the present disclosure provide an electrochemical machining apparatus for thin metal strips and a machining method thereof, for avoiding influences of residual stress, work roll surface damage, and deformation of a thin strip raw material on preparation of the thin strips, thereby improving a yield rate.

To achieve the above objective, the present disclosure provides the following technical solutions. In a first aspect, the present disclosure provides an electrochemical machining apparatus for thin metal strips, comprising: an upper fixture and a lower fixture arranged sequentially from top to bottom, a pressing part, a conveying mechanism, a power supply, a thickness gauge, a controller, a high-transmittance optical glass, and a high-speed camera. The upper fixture is provided with a through slot penetrating vertically and an electrolyte channel, the electrolyte channel is arranged around the through slot, and a surface of the lower fixture close to the upper fixture is provided with a groove perpendicular to a penetrating direction of the through slot. A machining area is formed between the groove and a lower surface of the upper fixture, the machining area communicates with both the electrolyte channel and the through slot, and the machining area is configured to accommodate a thin strip material. The pressing part is embedded in the through slot, a surface of the pressing part close to the machining area is configured to machine a surface of the thin strip material after being energized. The conveying mechanism is configured to convey the thin strip material from an input side of the machining area to an output side, and a conveying direction of the conveying mechanism is perpendicular to the penetrating direction of the through slot. A negative electrode of the power supply is connected to the pressing part, and a positive electrode of the power supply is connected to the thin strip material. The thickness gauge is located at the input side of the machining area, and the thickness gauge is configured to detect a thickness of the thin strip material. The controller is in control connection with the thickness gauge and the conveying mechanism, the controller is configured to control, according to the thickness detected by the thickness gauge, start and stop of the conveying mechanism. The high-transmittance optical glass is embedded in the upper fixture, the high-speed camera observes a surface of the thin strip material in the machining area through the high-transmittance optical glass, the high-speed camera is configured to collect electrolytic product distribution information on the thin strip material, the high-speed camera is in control connection with the controller, and the controller is further configured to control, according to the electrolytic product distribution information, a moving distance of the pressing part in a vertical direction.

In a second aspect, the present disclosure further provides an electrochemical machining method for thin metal strips, applied to the electrochemical machining apparatus for thin metal strips described above. The method comprises: S100, moving the upper fixture and the pressing part to an initial position and then keeping the upper fixture and the pressing part stationary; S200, introducing an electrolyte into the electrolyte channel to fill the electrolyte channel, and then closing the electrolyte channel; S300, connecting the positive electrode of the power supply to the thin strip material, and connecting the negative electrode of the power supply to the pressing part; S400, starting the conveying mechanism, conveying the thin strip material into the machining area, conveying the thin strip material to pass through the machining area at a constant speed, wherein the power supply uses the electrolyte as a medium in the machining area to electrically connect the thin strip material and the pressing part, and the electrolyte and the thin strip material undergo an electrochemical reaction to complete removal and thinning of a surface of the thin strip material; S500, after the thin strip material completes one cycle under conveyance of the conveying mechanism, turning off the power supply and the conveying mechanism, measuring the thickness of the thin strip material by the thickness gauge, and then driving the thin strip material to enter the input side of the machining area again, and adjusting a gap between a surface of the pressing part close to the machining area and a bottom surface of the groove in the vertical direction according to the thickness measured by the thickness gauge; and S600, repeating S400 to S500, measuring the thickness of the thin strip material by the thickness gauge until the thickness of the thin strip material after moving out of the machining area reaches a target thickness, and turning off the electrochemical machining apparatus for thin metal strips.

### BRIEF DESCRIPTION OF THE DRAWINGS

The drawings described herein are provided for further understanding of the present disclosure and constitute a part of the present disclosure. The illustrative embodiments and descriptions thereof in the present disclosure are used to explain the present disclosure and do not constitute an undue limitation of the present disclosure. In the drawings:

FIG. 1 is a schematic diagram illustrating an overall structure of an electrochemical machining apparatus for thin metal strips according to some embodiments of the present disclosure;

FIG. 2 is a schematic diagram illustrating a structure of a pressing part of an electrochemical machining apparatus for thin metal strips according to some embodiments of the present disclosure;

FIG. 3 is a schematic diagram illustrating a structure of an upper fixture and a lower fixture of an electrochemical machining apparatus for thin metal strips according to some embodiments of the present disclosure;

FIG. 4 is a cross-sectional diagram of FIG. 3 along the B-B direction (in a vertical direction of a straight line connected by an electrolyte channel);

FIG. 5 is a flowchart illustrating an exemplary process of an electrochemical machining method for thin metal strips according to some embodiments of the present disclosure.

### REFERENCE NUMERALS IN THE DRAWINGS

11-thin strip material; 12-upper fixture; 121-through slot; 122-electrolyte channel; 13-lower fixture; 131-groove; 2-pressing part; 3-conveying mechanism; 31-pulley; 32-conveyor belt; 4-thickness gauge; 5-controller; 51-data collector; 52-displacement control card; 6-high-speed camera; 7-high-transmittance optical glass; 8-machine tool; 81-machine tool spindle; 9-power supply.

### DETAILED DESCRIPTION

To make the technical problems to be solved by the present disclosure, technical solutions, and beneficial effects clearer and more comprehensible, the present disclosure is further described in detail below with reference to drawings and embodiments. It should be understood that the specific embodiments described herein are only used to explain the present disclosure and are not intended to limit the present disclosure.

It should be noted that when an element is referred to as being "fixed to" or "disposed on" another element, it may be directly on the other element or indirectly on the other element. When an element is referred to as being "connected to" another element, it may be directly connected to the other element or indirectly connected to the other element.

In addition, the terms "first" and "second" are used for descriptive purposes only and cannot be understood as indicating or implying relative importance or implicitly indicating the quantity of the indicated technical features. Thus, features defined with "first" and "second" may explicitly or implicitly include one or more of the features. In descriptions of the present disclosure, "a plurality of" means two or more, unless otherwise explicitly and specifically defined. "Several" means one or more, unless otherwise explicitly and specifically defined.

In descriptions of the present disclosure, it should be understood that the terms "upper", "lower", "front", "rear", "left", "right", etc. indicate the orientation or positional relationship based on the orientation or positional relationship shown in the accompanying drawings, and are only for the convenience of describing the present disclosure and simplifying the description, rather than indicating or implying that the referred device or element must have a specific orientation, be constructed and operated in a specific orientation, and therefore cannot be understood as a limitation of the present disclosure.

In descriptions of the present disclosure, it should be noted that unless otherwise explicitly specified and defined, the terms "installation", "linkage", and "connection" should be understood in a broad sense, for example, they may be fixed connections, detachable connections, or integrated connections; they may be mechanical connections or electrical connections; they may be direct connections or indirect connections through an intermediate medium, and they may be internal communication between two elements or an interaction relationship between two elements. For those of ordinary skill in the art, the specific meanings of the above terms in the present disclosure may be understood according to specific situations.

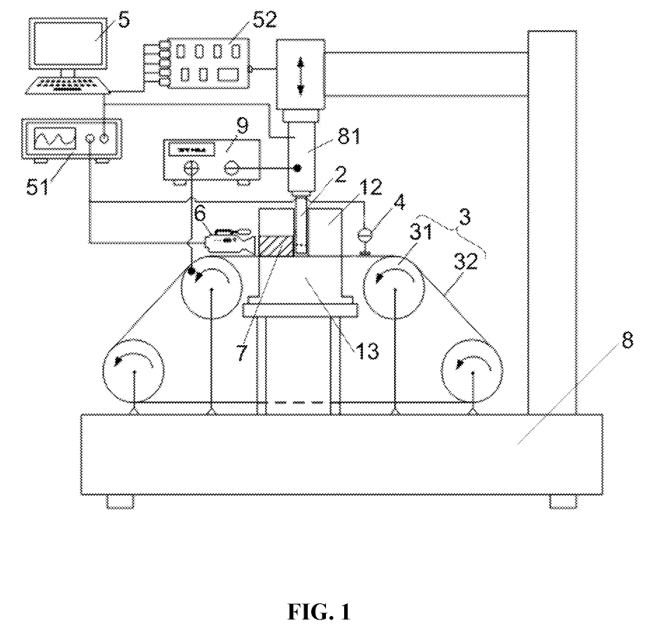

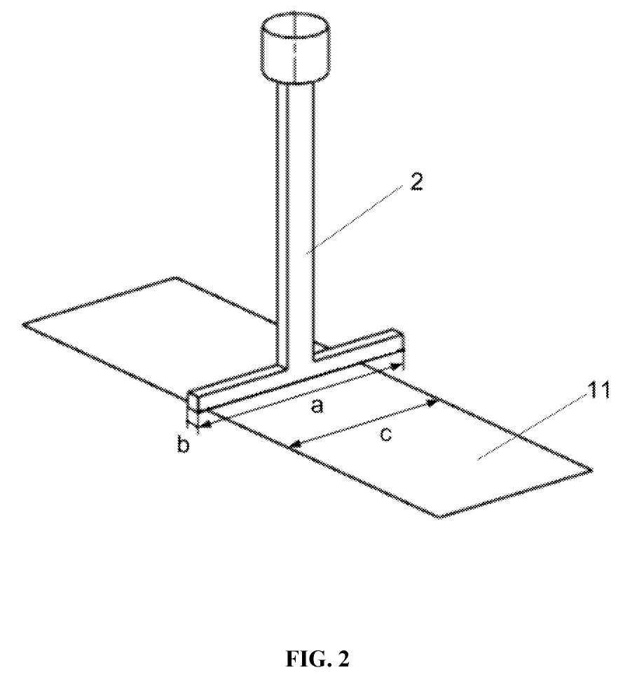

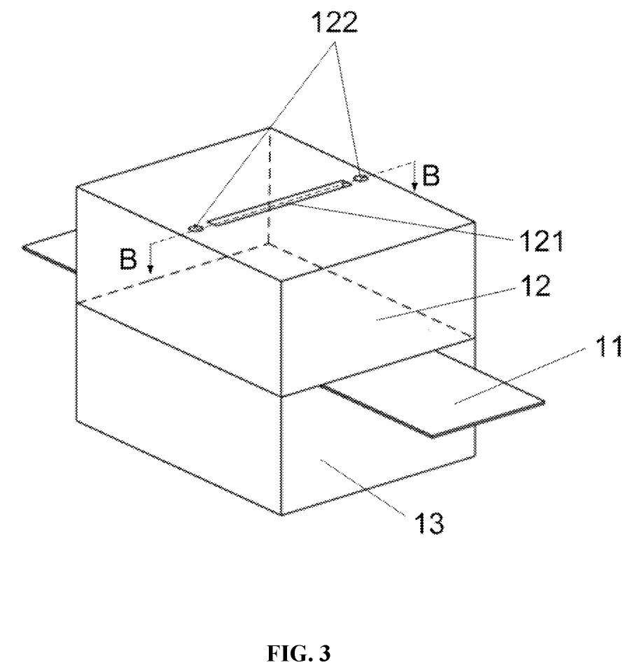

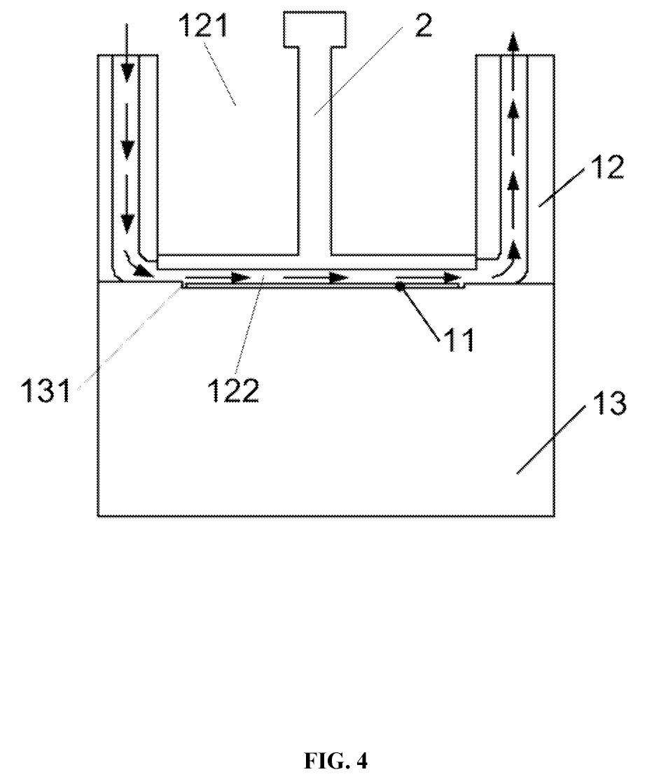

FIG. 1 is a schematic diagram illustrating an overall structure of an electrochemical machining apparatus for thin metal strips according to some embodiments of the present disclosure. FIG. 2 is a schematic diagram illustrating a structure of a pressing part of an electrochemical machining apparatus for thin metal strips according to some embodiments of the present disclosure. FIG. 3 is a schematic diagram illustrating a structure of an upper fixture and a lower fixture of an electrochemical machining apparatus for thin metal strips according to some embodiments of the present disclosure. FIG. 4 is a cross-sectional diagram of FIG. 3 along the B-B direction (in a vertical direction of a straight line connected by electrolyte channels).

In some embodiments, as shown in FIGS. 1-4, an electrochemical machining apparatus for thin metal strips is provided, hereinafter referred to as a machining apparatus. The machining apparatus includes: an upper fixture 12, a lower fixture 13, a pressing part 2, a conveying mechanism 3, a power supply 9, a thickness gauge 4, a controller 5, a high-transmittance optical glass 7, and a high-speed camera 6.

In some embodiments, the upper fixture 12 and the lower fixture 13 are arranged sequentially from top to bottom, the upper fixture 12 is provided with a through slot 121 penetrating up and down and an electrolyte channel 122, the electrolyte channel 122 is arranged around the through slot 121, and a surface of the lower fixture 13 close to the upper fixture 12 is provided with a groove 131 perpendicular to a penetration direction of the through slot 121. A machining area is formed between the groove 131 and a lower surface of the upper fixture 12, the machining area is communicated with both the electrolyte channel 122 and the through slot 121, and the machining area is configured to accommodate a thin strip material 11. The pressing part 2 is embedded in the through slot 121, and a surface of the pressing part 2 close to the machining area is configured to machine a surface of the thin strip material 11 after being energized. The conveying mechanism 3 is configured to convey the thin strip material 11 from an input side of the machining area to an output side, and a conveying direction of the conveying mechanism 3 is perpendicular to the penetration direction of the through slot 121. A negative electrode of the power supply 9 is connected to the pressing part 2, and a positive electrode of the power supply 9 is connected to the thin strip material 11. The thickness gauge 4 is located at the input side of the machining area, and the thickness gauge 4 is configured to detect a thickness of the thin strip material 11. The controller 5 is in control connection with the thickness gauge 4 and the conveying mechanism 3, and the controller 5 is configured to control starting and stopping of the conveying mechanism 3 according to a thickness detected by the thickness gauge 4. The high-transmittance optical glass 7 is embedded in the upper fixture 12, the high-speed camera 6 observes a surface of the thin strip material 11 in the machining area through the high-transmittance optical glass 7, the high-speed camera 6 is configured to collect electrolytic product distribution information on the thin strip material 11, the high-speed camera 6 is in control connection with the controller 5, and the controller 5 is further configured to control a moving distance of the pressing part 2 in a vertical direction according to the electrolytic product distribution information.

The upper fixture 12 and the lower fixture 13 are two fixture components arranged sequentially from top to bottom and are configured to fix the thin strip material 11 and form a machining area.

In some embodiments, a material of the lower fixture 13 includes a ferromagnetic alloy, and/or a material of the upper fixture 12 includes a high molecular polymer.

In some embodiments, a material of the lower fixture 13 may be an AlNiCo magnet or other ferromagnetic alloys, which is not specifically limited herein. Since the ferromagnetic alloys have excellent magnetic properties and a small temperature coefficient, when the thin strip material 11 enters the machining area and is adsorbed in the groove 131 of the lower fixture 13 made of the ferromagnetic alloys, avoiding deformation of the thin strip material 11 due to insufficient rigidity during clamping to ensure a machining accuracy.

In some embodiments, a material of the upper fixture 12 is a high molecular polymer. The upper fixture 12 may be high-temperature resistant plastic, rubber, or other high molecular polymers, which is not specifically limited herein. Since the high molecular polymer has corrosion resistance and insulating properties, during an electrochemical machining process, the upper fixture 12, the pressing part 2, the thin strip material 11, and the lower fixture 13 may reduce conduction of current and heat, and resist erosion and corrosion of various chemical substances, thereby extending a service life of the machining apparatus, while avoiding shape errors and other problems of the thin strip material 11 during a clamping process due to its insufficient rigidity, ensuring a machining accuracy of the thin strip material 11.

The through slot 121 is a vertically penetrating slot provided on the upper fixture 12. The through slot 121 may be configured to embed the pressing part 2. The through slot 121 communicates with both the machining area and the electrolyte channel 122. In the machining apparatus, the pressing part 2 may move in a vertical direction within the through slot 121 to adjust a machining gap between a surface of the pressing part 2 close to the machining area and a bottom surface of the groove 131.

The electrolyte channel 122 is a channel structure arranged around the through slot 121. The electrolyte channel 122 may introduce the electrolyte into the machining area. In some embodiments, a cross-sectional shape of the electrolyte channel 122 may be circular, elliptical, square, diamond-shaped, etc.

In some embodiments, the through slot 121 and the electrolyte channel 122 are arranged to penetrate vertically.

Merely by way of example, the through slot 121 and the electrolyte channel 122 may penetrate from an upper surface of the upper fixture 12 to a lower surface of the upper fixture 12.

In some embodiments, a surface of the lower fixture 13 close to the upper fixture 12 is provided with a groove 131 perpendicular to a penetration direction of the through slot.

The groove 131 refers to a concave slot structure disposed on a surface of the lower fixture 13 that is close to the upper fixture 12. In some embodiments, a shape of the groove 131 includes a cuboid, a semi-cylinder, or other polyhedrons, etc.

The surface of the lower fixture 13 that is close to the upper fixture 12 refers to a surface of the lower fixture 13 that faces the upper fixture 12. As shown in FIG. 3, the surface of the lower fixture 13 that is close to the upper fixture 12 is an upper surface of the lower fixture 13.

The penetration direction of the through slot 121 refers to an extending direction of the through slot 121 in the upper fixture 12. As shown in FIG. 3, the penetration direction of the through slot 121 is a vertically downward direction.

The machining area is an area formed between the groove 131 and a lower surface of the upper fixture 12. A shape of the machining area may be the same as a shape of the groove 131. The machining area is configured to perform an electrolytic processing on the thin strip material 11.

In some embodiments, the machining area includes an input side and an output side.

The input side refers to a side where the thin strip material 11 enters the machining area.

The output side refers to a side where the thin strip material 11 leaves the machining area.

As shown in FIG. 1, when a pulley 31 of the conveying mechanism 3 rotates counterclockwise, the input side is a right side of the upper fixture 12 and the lower fixture 13, and the output side is a left side of the upper fixture 12 and the lower fixture 13.

The thin strip material 11 (also referred to as a thin strip or a formed workpiece) refers to a material used for electrochemical machining. For example, the thin strip material 11 includes a screen substrate of an artificial satellite or a flexible display screen, key domes of an electronic component, a vascular stent, etc.

The pressing part 2 is a conductive component embedded in the through slot 121. After being energized, the pressing part 2 serves as a cathode to perform surface electrochemical machining on the thin strip material 11. In some embodiments, the pressing part 2 may be connected to a negative electrode of the power supply 9.

A surface of the pressing part 2 that is close to the machining area is a surface of the pressing part 2 that faces the thin strip material 11. As shown in FIG. 2, the surface of the pressing part 2 that is close to the machining area is a vertically downward surface of the pressing part 2.

As shown in FIG. 4, in some embodiments, a contour shape of the pressing part 2 includes a T-shape, a rectangle, or a U-shape, etc.

In some embodiments, by providing a plurality of optional contour shapes of the pressing part 2, different machining requirements for different thin strip materials 11 are met, so as to improve applicability of the machining apparatus.

In some embodiments, the pressing part 2 may also be other contour shapes, which is not specifically limited herein. The pressing part 2 has a machining plane that is capable of contacting the machining area.

In some embodiments, the pressing part 2 includes a machining plane, and the machining plane contacts the machining area.

The machining plane refers to a flat surface on the pressing part 2 that participates in electrochemical machining. For example, as shown in FIG. 2, the machining plane is a lower surface of the pressing part 2.

In some embodiments, a width b of the machining plane of the pressing part 2 is less than or equal to 10 mm, and a length a of the machining plane is greater than a width c of the thin strip material 11.

In some embodiments, by setting a size of the machining plane of the pressing part 2, a current density distribution during machining is uniform, so as to ensure a machining quality.

In some embodiments, the pressing part 2 has a machining plane that is capable of contacting the machining area, which provides structural support for an electrochemical reaction and ensures uniformity of removal and thinning of the thin strip material 11.

The conveying mechanism 3 is a structure configured to convey the thin strip material 11. The conveying mechanism 3 conveys the thin strip material 11 from the input side of the machining area to the output side.

A conveying direction refers to a moving direction when the thin strip material 11 is conveyed. For example, the conveying direction includes a direction from the input side to the output side.

In some embodiments, as shown in FIG. 1, when the pulley 31 of the conveying structure 3 rotates counterclockwise, the conveying direction is a horizontal direction from right to left.

In some embodiments, the conveying mechanism 3 includes: a plurality of pulleys 31, a conveyor belt 32, and a second driving component. The plurality of pulleys 31 are arranged at intervals. The conveyor belt 32 covers the plurality of pulleys 31 and forms a closed loop. The conveyor belt 32 is configured to cyclically convey the thin strip material 11. A driving end of the second driving component is connected to the plurality of pulleys 31. The second driving component is in control connection with the controller 5. The controller 5 is further configured to control the second driving component to drive the pulley 31 to rotate, and the pulley 31 drives the conveyor belt 32 to rotate.

The pulley 31 is a component that supports and drives the conveyor belt 32 to move.

In some embodiments, the number of the pulleys 31 is 2, 3, 5, etc., which is not specifically limited herein. The conveyor belt 32 covers each pulley 31 and forms a closed loop.

Arrangement at intervals refers to a distribution manner in which the plurality of pulleys 31 are spaced apart by a certain distance to form a stable conveying path. The intervals of the arrangement at intervals include uniform intervals or non-uniform intervals.

The conveyor belt 32 refers to a carrier structure that carries and conveys the thin strip material 11. The conveyor belt 32 is a strip-shaped structure made of rubber, metal, plastic, or the like.

The second driving component refers to an apparatus that provides a power for the conveying mechanism 3. For example, the second driving component is an electric motor, an engine, or the like.

The driving end of the second driving component is a component that transmits a driving torque or motion to the plurality of pulleys 31 and causes the plurality of pulleys 31 to rotate. For example, the driving end of the second driving component includes a transmission shaft, a gear, a sprocket, or the like.

In some embodiments, during operation, the second driving component only needs to drive one of the plurality of pulleys 31 to rotate, and friction between the conveyor belt 32 and the pulley 31 drives the conveyor belt 32 to move. The thin strip material 11 placed on the conveyor belt 32 is uniformly conveyed into the machining area for electrochemical machining. That is, the conveyor belt 32 and the thin strip material 11 together pass through the machining area for convenient operation.

In some embodiments, by designing the plurality of pulleys 31 and the conveyor belt 32 as a closed loop structure and driving the plurality of pulleys 31 and the conveyor belt 32 by the second driving component and the controller 5, cyclic conveying of the thin strip material 11 is conveniently achieved. This ensures that the thin strip material 11 passes through the machining area at a constant and stable speed and guarantees stable overall machining precision during continuous electrochemical machining.

The power supply 9 is a component that provides energy for electrochemical machining. The power supply 9 may include a battery, a direct current power supply, a pulse power supply, etc.

The thickness gauge 4 is a component configured to detect a thickness of the thin strip material 11. Merely by way of example, the thickness gauge 4 may include a laser thickness gauge, an ultrasonic thickness gauge, etc.

The thickness of the thin strip material 11 may also be referred to as thickness information of the thin strip material 11.

The control connection refers to a communication connection established between the controller 5 and another component (e.g., the second driving component, etc.). The controller 5 is configured to receive data and send instructions via the control connection, thereby achieving automated adjustment and precise control to other components.

Merely by way of example, the controller 5 may receive a thickness detected by the thickness gauge 4 and send an instruction to the conveying mechanism 3 to stop operation in response to a determination that the thickness is not within a preset thickness range. The preset thickness range may be a range preset by a user.

The high-transmittance optical glass 7 is an observation window provided on the machining apparatus. The high-transmittance optical glass 7 may include quartz glass, sapphire glass, organic glass, etc. The high-transmittance optical glass 7 may be a flat plate structure.

The high-speed camera 6 is an apparatus configured to monitor a machining process. Merely by way of example, the high-speed camera 6 may obtain image information, etc., during a machining process.

Electrolytic product distribution information refers to information reflecting generation, movement, or accumulation of electrolytic reaction products within the machining area. Electrolytic products may include gas, metal hydrate, metal precipitate, etc.

In some embodiments, the electrolytic product distribution information may be collected through photographing, video recording, etc. by the high-speed camera 6.

The controller 5 is a unit configured to receive data, process data, or send instructions. The controller 5 may include a Programmable Logic Controller (PLC), a Central Processing Unit (CPU), an industrial computer, an embedded system, etc.

In some embodiments, a processor provided in the electrochemical machining apparatus for thin metal strips may be integrated into the controller 5.

As shown in FIG. 1 to FIG. 4, a vertical direction of the pressing part 2 may be a direction in which the pressing part 2 is perpendicular to an upper surface of the thin strip material 11. The vertical direction of the pressing part 2 may be a penetrating direction of the through slot 121.

In some embodiments, a movement distance of the pressing part 2 in the vertical direction is also a spacing between a lower surface of the pressing part 2 and an upper surface of the groove 131.

In some embodiments, the controller 5 may control the movement distance of the pressing part 2 in the vertical direction based on the electrolytic product distribution information through various manners.

There are two known situations: a degree of electrolytic removal in different regions of the thin strip material 11 does not satisfy a preset condition, and a degree of electrolytic removal in different regions of the thin strip material 11 satisfies the preset condition.

In some embodiments, the controller 5 may analyze the electrolytic product distribution information at different times to determine the degree of the electrolytic removal in different regions of the thin strip material 11. In response to a determination that the degree of the electrolytic removal in different regions of the thin strip material 11 does not satisfy the preset condition, the controller 5 may adjust a vertical movement distance of the pressing part 2 to correct removal amount in the different regions.

In some embodiments, an adjustment amount for the vertical movement distance of the pressing part 2 may be negatively correlated with an amount of electrolytic product distribution. Different components of electrolytic products correspond to different adjustment amounts for the vertical movement distance of the pressing part 2, which may be preset by professional technicians.

The different time may be set by professional technicians.

The preset condition refers to a pre-defined condition for judging machining uniformity of the thin strip material 11. Merely by way of example, the preset condition may include that the amounts of electrolytic product distribution in different regions of the thin strip material 11 is different, components of electrolytic products are different, etc.

In some embodiments, the machining apparatus further includes a first driving component, a driving end of the first driving component is connected to a side of the pressing part 2 away from the machining area, and the first driving component is in control connection with the controller 5. The first driving component is configured to drive the pressing part 2 to move along a vertical direction.

The first driving component is a component configured to drive the pressing part 2. The first driving component is similar to the second driving component, with a difference lying in the components they drive. More descriptions may be found in above contents in the disclosure, which is not repeated herein.

The driving end of the first driving component is a component configured to transmit a driving force to the pressing part 2. The driving end of the first driving component is similar to the driving end of the second driving component, with a difference lying in components they connect. More descriptions may be found in above contents in the disclosure, which is not repeated herein.

The side of the pressing part 2 away from the machining area refers to a surface that does not participate in electrochemical machining and is away from the thin strip material 11 and the groove 131. As shown in FIG. 2, the side of the pressing part 2 away from the machining area may be an upper side of the pressing part 2.

new paragraph...

In some embodiments, by adding the first driving component, connecting the driving end of the first driving component to the side of the pressing part 2 away from the machining area, and controlling the controller 5 to drive the pressing part 2 to move along the vertical direction, automated adjustment and control of a machining gap and a removal amount can be ensured.

As shown in FIG. 1, in some embodiments, the machining apparatus further includes a machine tool spindle 81, a data collector 51, and a displacement control card 52.

In some embodiments, the lower fixture 13 is disposed on a machine tool 8, the pressing part 2 is capable of moving to a tool setting position with the machine tool spindle 81 and then remaining stationary (i.e., movement of the pressing part 2 along the vertical direction may be achieved by driving of the machine tool spindle 81, and the machine tool spindle 81 may serve as the first driving component at this time). The lower fixture 13 is fixedly connected to the machine tool 8.

In some embodiments, the data collector 51, the controller 5, and the displacement control card 52 are sequentially connected. The displacement control card 52 is configured to receive output data from the controller 5 and feed the output data back to the machine tool spindle 81, enabling the machine tool spindle 81 to drive the pressing part 2 to move along a vertical direction. The data collector 51 is configured to collect monitoring data from the thickness gauge 4 and the high-speed camera 6 and transmits the monitoring data to the controller 5. The controller 5 controls the first driving component, the second driving component, and the displacement control card 52 respectively, to achieve control of a distance between the pressing part 2 and the thin strip material 11 and control of the conveying mechanism 3, thereby facilitating installation and operation.

The data collector 51 is a component configured to collect data and transmit data. The data collector 51 may include a data acquisition card, a data gateway, a bus interface, etc.

The displacement control card 52 is responsible for converting a control instruction into a signal for driving movement of the machine tool spindle 81. The displacement control card 52 is configured to convert a control instruction sent by a controller 5 into a signal for driving a first driving component or a second driving component to displace. The displacement control card 52 may include a motion control card, an interface control card, or the like.

In some embodiments of the present disclosure, the pressing part 2 and the thin strip material 11 are connected to the power supply 9. The conveying mechanism 3 conveys the thin strip material 11 through the electrolyte channel 122 to perform electrolytic removal on a surface of the thin strip material. The thickness gauge 4 detects thickness information of the thin strip material 11 and feeds the thickness information back to the controller 5, and a position of the pressing part 2 in the through slot 121 is adjusted. By repeating above operations until a target thickness is reached, a yield rate of the thin strip material 11 can improved.

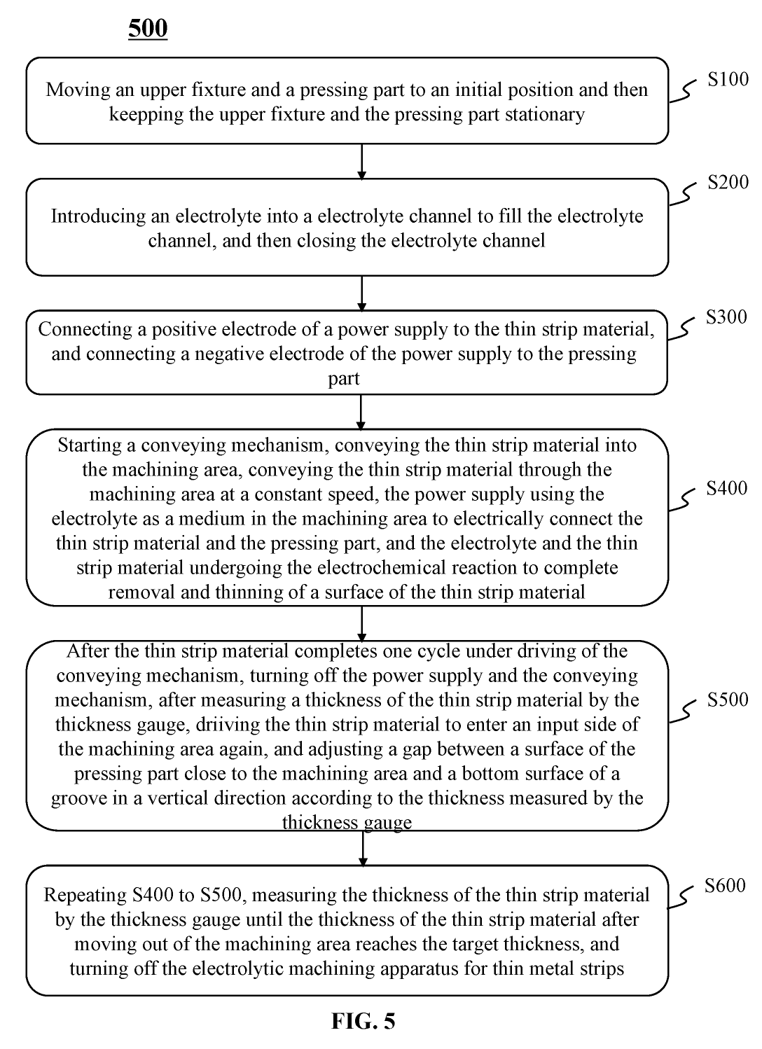

FIG. 5 is a flowchart illustrating an exemplary process of an electrochemical machining method for thin metal strips according to some embodiments of the present disclosure.

In some embodiments, the present disclosure further provides an electrochemical machining method for thin metal strips. The method is applied to the electrochemical machining apparatus f or thin strips described above. The method is performed by the controller 5. The electrochemical machining method for thin metal strips includes the following operations S100 to S600.

S100, moving an upper fixture 12 and a pressing part 2 to an initial position and then keeping the upper fixture 12 and the pressing part 2 stationary.

The initial position refers to a reference position to which the upper fixture 12 and the pressing part 2 need to be moved and maintained before starting to perform an electrochemical machining process for thin metal strips (i.e., step S100). The initial position is preset by a professional technician.

S200, introducing an electrolyte into an electrolyte channel 122 to fill the electrolyte channel 122, and then closing the electrolyte channel 122.

The electrolyte is a medium for conducting current and performing an electrochemical reaction in a machining area. The controller 5 is configured to control a liquid injection hole of an electrolyte injection device (not shown in the figure) to connect to the electrolyte channel 122, and then inject the electrolyte into the electrolyte channel 122.

In some embodiments, the electrolyte includes a sodium nitrate solution, a sodium chloride solution, or another neutral solution.

In some embodiments, a composition and a content of the electrolyte are adjusted according to different materials, processing requirements, etc., and are not specifically limited herein.

By using the sodium nitrate solution, the sodium chloride solution, or another neutral solution as the electrolyte, an electrochemical machining function can be ensured to achieve. The composition or the content of the electrolyte are adjusted according to materials or requirements, which can enhance versatility and application flexibility of the machining apparatus.

In some embodiments, a concentration of the electrolyte is within a range of 5%-50%.

By setting a reasonable concentration range, the electrolyte has good conductivity and electrochemical reaction activity, ensuring stability and efficiency of the electrochemical machining process, so as to avoid processing instability or poor effect caused by an excessively high or low concentration.

In some embodiments, an inlet pressure of the electrolyte is within a range of 0.00 MPa-2.00 MPa.

The inlet pressure is monitored by a pressure gauge (not shown in the figure) disposed in the electrolyte channel 122.

By controlling the inlet pressure of the electrolyte, a flow rate and a flow state of the electrolyte in a machining gap are effectively controlled, to remove an electrolytic product (e.g., a bubble, a precipitate, etc.) on the thin strip material 11 in time, so as to ensure a current density in the machining area being uniform and stable, prevent decrease in machining precision, and improve overall machining efficiency.

In some embodiments, a temperature of the electrolyte is within a range of 0°C-50°C.

In some embodiments, when the machining apparatus is working, the concentration of the electrolyte is set according to different materials or processing requirements. Merely by way of example, the concentration of the electrolyte is 5%, 16%, 30%, 45%, 50%, etc. When the machining apparatus is working, the inlet pressure of the introduced electrolyte is 0.00 MPa, 0.12 MPa, 0.20 MPa, 1.35 MPa, 2.00 MPa, etc., and the temperature of the electrolyte is 0°C, 10°C, 25°C, 42°C, 50°C, etc. The inlet pressure of the electrolyte and the temperature of the electrolyte are not specifically limited herein as long as processing requirements are met.

By controlling the temperature of the electrolyte, stability and reaction activity of the electrolyte can be effectively maintained. An appropriate temperature can ensure that conductivity of the electrolyte is in an optimal state, while avoiding decomposition of the electrolyte or aggravated corrosion caused by an excessively high temperature and avoiding an excessively slow electrochemical reaction rate caused by an excessively low temperature, so as to ensure stability and efficiency of the machining process.

S300, connecting a positive electrode of a power supply 9 to the thin strip material 11, and connecting a negative electrode of the power supply 9 to the pressing part 2.

In some embodiments, a machining voltage of the power supply 9 is within a range of 0 V-40 V.

For example, the machining voltage of the power supply 9 is 0 V, 20 V, 35 V, 40 V, etc. The machining voltage of the power supply 9 is not specifically limited herein. It is only required that the machining voltage applied between the pressing part 2 and the thin strip material 11 is within a range of 0 V-40 V.

By setting the machining voltage within a range of 0 V-40 V, effectiveness and stability of the electrochemical reaction can be ensured, ensuring a sufficient current density to achieve effective removal and thinning of the thin strip material 1, avoiding excessive decomposition of the electrolyte, discharge, or short circuit caused by an excessively high voltage, so as to ensure safety and precision of machining.

S400, starting a conveying mechanism 3 to convey the thin strip material 11 into the machining area and convey the thin strip material 11 through the machining area at a constant speed, the power supply 9 using the electrolyte as a medium in the machining area to electrically connect the thin strip material 11 and the pressing part 2, and the electrolyte and the thin strip material 11 undergoing the electrochemical reaction to complete removal and thinning of a surface of the thin strip material 11.

In some embodiments, a moving speed of the thin strip material 11 is within a range of 1.00 mm/min-20.00 mm/min. The controller 5 is configured to adjust the moving speed of the thin strip material 11 according to different materials and different processing requirements. Merely by way of example, the moving speed of the thin strip material 11 is 1.00 mm/min, 1.50 mm/min, 5.00 mm/min, 12.00 mm/min, 20.00 mm/min, etc. The moving speed of the thin strip material 11 is not specifically limited herein.

By setting a reasonable moving speed of the thin strip material 11, the thin strip material 11 has sufficient residence time in the machining area to complete a required electrochemical removal and thinning amount. An appropriate speed also ensures that the electrolytic product is removed in time so as to maintain stability and efficiency of machining.

The removal and thinning refer to removing a portion of a substance from a surface of the thin strip material 11 through the electrochemical reaction, thereby reducing a thickness of the thin strip material 11.

S500, after the thin strip material 11 completes one cycle under driving of the conveying mechanism 3, turning off the power supply 9 and the conveying mechanism 3, after measuring a thickness of the thin strip material 11 by the thickness gauge 4, driving the thin strip material 11 to enter an input side of the machining area again, adjusting a gap in a vertical direction between a surface of the pressing part 2 close to the machining area and a bottom surface of a groove 131 according to the thickness measured by the thickness gauge 4.

In some embodiments, the controller 5 controls the first driving component to drive the pressing part 2 to move in the vertical direction according to the thickness measured by the thickness gauge 4, so as to adjust the gap between the surface of the pressing part 2 close to the machining area and the bottom surface of the groove 131. For example, when thinning of the thin strip material 11 causes the gap to increase, the controller 5 controls the first driving component to drive the pressing part 2 to move downward by analyzing a thickness difference until the gap returns to a preset value, thereby ensuring that the gap is constant.

S600, repeating S400 to S500, measuring the thickness of the thin strip material 11 by the thickness gauge 4 until the thickness of the thin strip material 11 after moving out of the machining area reaches the target thickness, and turning off the electrochemical machining apparatus for thin metal strips.

In some embodiments, in S600, when a thickness measurement range of the thickness gauge 4 is within a range of A-0.001 mm to A+0.001 mm (where A is the target thickness of the thin strip material 11), a machining requirement is met, and the electrochemical machining apparatus for thin metal strips is turned off at this time.

The target thickness is preset by a professional technician.

In some embodiments, as shown in FIG. 1, when the machining apparatus is working, the pressing part 2 is connected to the negative electrode of the power supply 9, and the thin strip material 11 is connected to the positive electrode of the power supply 9. The thickness gauge 4 detects a thickness of the thin strip material 11 conveyed to the machining area. In a machining area, the conveying mechanism 3 continuously conveys the thin strip material 11 through the electrolyte channel 122, so that the space between the pressing part 2 and the thin strip material 11 is filled with a stationary electrolyte.

Through the electrochemical reaction, the surface of the thin strip material 11 is thinned. The machined thin strip material 11 is conveyed by the conveying mechanism 3 to the input side of the machining area again, the thickness gauge 4 detects the thickness of the thin strip material 11, and an operator adjusts the position of the pressing part 2 in a through slot 121 according to the thickness measured by the thickness gauge 4.

After the adjustment is completed, S400 to S500 are continuously repeated to perform secondary removal on the surface of the thin strip material 11 until the thin strip material 11 reaches the target thickness, and the electrochemical machining apparatus for thin metal strips is turned off to complete machining of the thin strip material 11.

In the present disclosure, the pressing part 2 and the thin strip material 11 are machined in a non-contact manner, avoiding residual stress on the surface of the thin strip material 11 during a rolling process. Compared with manners in traditional electrochemical machining in which the thin strip material 11 is placed in a flowing electrolyte for flushing treatment, in the present disclosure, the pressing part 2 and the thin strip material 11 are machined in a non-contact manner, the electrolyte in the electrolyte channel 122 is in a stationary state during machining, and the controller 5 continuously adjusts the position of the pressing part 2 in the through slot 121 until the thickness of the thin strip material 11 meets a manufacturing requirement, reducing a risk of deformation of the thin strip material 11 caused by flushing with the flowing electrolyte so as to ensure manufacturing quality of the thin strip material 11 and improve a yield rate.

In some embodiments, during movement of the thin strip material 11 in the machining area, a small amount of the electrolyte flows out through a gap between the machining area and the thin strip material 11, the outflowed electrolyte is collected outside the machining area. Alternatively, before the thin strip material 11 enters the machining area each time, the input side and an output side of the machining area are blocked with paraffin to slow down outflow of the electrolyte from the machining area.

When the machining apparatus is working, after each machining of the thin strip material 11 is completed, the conveying mechanism 3 conveys the thin strip material 11 to the thickness gauge 4 for measurement, and the measured thickness information is transmitted to the controller 5. The controller 5 controls the first driving component to move by analyzing the thickness, so as to drive the pressing part 2 to move in the vertical direction in the through slot 121 to change a machining gap between the surface of the pressing part 2 close to the machining area and a bottom surface of the groove 131. Compared to conventional operation where an operator controls the machining position of the pressing part 2 within a through slot 121, the method described in the present disclosure employs a controller 5 to control driving of a first driving component, which can ensure that a removal amount of the surface of the thin strip material 11 is equal after each cycle, thereby improving machining precision of the machining apparatus.

During operation of the machining apparatus, a high-speed camera 6 is positioned at an output side of the machining area. While the conveying mechanism 3 conveys the thin strip material 11 within the machining area, the high-speed camera 6 monitors and analyzes, through a high-transmittance optical glass 7, electrolytic product distribution information on the surface of the thin strip material 11 in real time. During a machining process, a gap may be maintained between the pressing part 2 and the thin strip material 11, i.e., a machining gap. After the thin strip material 11 completes one cycle of machining, thinning of the thin strip causes the gap between the pressing part 2 and the thin strip material 11 to increase, and the thickness gauge 4 detects the thickness of the thin strip material 11 after machining. If the thickness of the thin strip material 11 does not meet a requirement (e.g., a target thickness is not reached), the controller 5 controls the conveying mechanism 3 to stop. Simultaneously, the first driving component activates to drive the pressing part 2 to move in a vertical direction within the through slot 121 until a machining gap between the surface of the pressing part 2 close the machining area and a bottom surface of the groove 131 meets a machining requirement (i.e., the thickness of the thin strip material 11 is fed back to the controller 5, and the controller 5 controls, based on the thickness of the thin strip material 11, movement of the first driving component to adjust the position of the pressing part 2 inside an upper fixture 12 to maintain an original machining gap, thereby completing adjustment of the machining gap). Subsequently, the electrolyte channel 122 is refilled with electrolyte, i.e., after replacing with new electrolyte and sealing a liquid inlet and a liquid outlet, the conveying mechanism 3 is activated again to convey the thin strip material 11 into the machining area. S400 to S500 are repeated to complete a plurality of machining processes on the surface of the thin strip material 11 until the thickness of the thin strip material 11 reaches the target thickness. While the thin strip material 11 undergoes electrochemical machining within the machining area, the controller 5 may control, based on the electrolytic product distribution information on the surface of the thin strip material 11 detected by the high-speed camera 6, the first driving component to activate in real time. The first driving component drives the pressing part 2 to move a corresponding distance along the vertical direction (i.e., adjusting the gap between the surface of the pressing part 2 close the machining area and the bottom surface of the groove 131), thereby allowing for adjustment based on differing electrolytic product distributions at different positions on the thin strip material 11, resulting in different machining gaps at different positions, and further ensuring that a removal amount of the thin strip material 11 is equal in different regions, so as to improve the machining precision of the machining apparatus.

Through S100-S600, a plurality of electrochemical machining processes on the thin strip material 11 may be completed within the machining area. After the thin strip material 11 meets the thickness requirement (i.e., the removal amount of the thin strip material 11 is equal in different regions and the target thickness is reached), components such as the power supply 9, the controller 5, and the conveying mechanism 3 are turned off, which has convenient operation and improves machining precision.

During operation of the machining apparatus, the pressing part 2 is connected to the negative electrode of the power supply 9, and the thin strip material 11 is connected to the positive electrode of the power supply 9. The thickness gauge 4 detects the thickness of the thin strip material 11 conveyed into the machining area. Within the machining area, the conveying mechanism 3 continuously conveys the thin strip material through the electrolyte channel 122, causing the space between the pressing part 2 and the thin strip material 11 to be filled with electrolyte. Through the electrochemical reaction, the surface of the thin strip material 11 is removed and thinned. The thin strip material 11 after machining is conveyed and transported by the conveying mechanism 3 again to the input side of the machining area. The thickness gauge 4 detects the thickness of the thin strip material 11, and a position of the pressing part 2 within the through slot 121 may be adjusted based on the thickness measured by the thickness gauge 4. After adjustment is completed, aforementioned operations are continued to be repeated to perform secondary removal on the surface of the thin strip material 11. Once the machined thin strip material 11 reaches the target thickness, the machining apparatus is turned off and the machining of the thin strip material 11 is completed. Compared to rolling forming or traditional electrochemical machining manners (e.g., placing the thin strip material 11 in a flowing electrolyte), the present disclosure involves non-contact machining between the pressing part 2 and the thin strip material 11, during the machining process, the electrolyte within the flow channel is stationary, the controller 5 dynamically adjusts the position of the pressing part 2 within the through slot 121, ensuring that the thickness of the machined thin strip material 11 meets manufacturing requirements, so as to avoid residual stress on the surface of the thin strip material 11 present in rolling processes, and also avoid a risk of deformation of the thin strip material 11 caused by flushing of flowing electrolyte during electrochemical machining, thereby improving the machining quality and yield rate of the thin strip material 11.

In descriptions of above embodiments, specific features, structures, materials, or characteristics may be combined in any suitable manner in one or more embodiments or examples.

Foregoing descriptions are merely specific implementations of the present disclosure, but the protection scope of the present disclosure is not limited thereto. Any person skilled in the art may easily conceive of changes or substitutions within the technical scope disclosed in the present disclosure, and these should be covered within the protection scope of the present disclosure. Therefore, a protection scope of the present disclosure should be subject to a protection scope of the claims.

What is claimed is:

1. An electrochemical machining apparatus for thin metal strips, comprising:
an upper fixture and a lower fixture arranged sequentially from top to bottom, wherein the upper fixture is provided with a through slot penetrating up and down and an electrolyte channel, the electrolyte channel is arranged around the through slot, a surface of the lower fixture close to the upper fixture is provided with a groove perpendicular to a penetrating direction of the through slot, a machining area is formed between the groove and a lower surface of the upper fixture, the machining area is communicated with both the electrolyte channel and the through slot, and the machining area is configured to accommodate thin strip material;
a pressing part, wherein the pressing part is embedded in the through slot, and a surface of the pressing part close to the machining area is configured to machine a surface of the thin strip material after being energized;
a conveying mechanism, wherein the conveying mechanism is configured to convey the thin strip material from an input side of the machining area to an output side of the machining area, and a conveying direction of the conveying mechanism is perpendicular to the penetrating direction of the through slot;
a power supply, wherein a negative electrode of the power supply is connected to the pressing part, and a positive electrode of the power supply is connected to the thin strip material;
a thickness gauge, wherein the thickness gauge is located at the input side of the machining area, and the thickness gauge is configured to detect a thickness of the thin strip material;
a controller, wherein the controller is in control connection with the thickness gauge and the conveying mechanism, and the controller is configured to control start and stop of the conveying mechanism according to the thickness detected by the thickness gauge; and
a high-transmittance optical glass and a high-speed camera, wherein the high-transmittance optical glass is embedded in the upper fixture, the high-speed camera observes the surface of the thin strip material in the machining area through the high-transmittance optical glass, the high-speed camera is configured to collect electrolytic product distribution information on the thin strip material, and the high-speed camera is in control connection with the controller, and the controller is further configured to control a movement distance of the pressing part in a vertical direction according to the electrolytic product distribution information.

2. The electrochemical machining apparatus for thin metal strips according to claim 1, further comprising: a first driving component, wherein a driving end of the first driving component is connected to a side of the pressing part away from the machining area, and the first driving component is in control connection with the controller, and the first driving component is configured to drive the pressing part to move in the vertical direction.

3. The electrochemical machining apparatus for thin metal strips according to claim 1, wherein a material of the lower fixture comprises a ferromagnetic alloy; and/or a material of the upper fixture comprises a high molecular polymer.

4. The electrochemical machining apparatus for thin metal strips according to claim 1, wherein a contour shape of the pressing part comprises at least one of a T-shape, a rectangle, or a U-shape.

5. The electrochemical machining apparatus for thin metal strips according to claim 1, wherein the pressing part comprises a machining plane, and the machining plane is in contact with the machining area.

6. The electrochemical machining apparatus for thin metal strips according to claim 5, wherein a width of the machining plane of the pressing part is less than or equal to 10 mm, and a length of the machining plane is greater than a width of the thin strip material.

7. The electrochemical machining apparatus for thin metal strips according to claim 1, wherein the conveying mechanism comprises:
a plurality of pulleys, wherein the plurality of pulleys are arranged at intervals;
a conveyor belt, wherein the conveyor belt covers the plurality of pulleys and forms a closed loop, and the conveyor belt is configured to cyclically convey the thin strip material; and
a second driving component, wherein a driving end of the second driving component is connected to the plurality of pulleys, and the second driving component is in control connection with the controller, and the controller is further configured to control the second driving component to drive rotation of the conveyor belt.

8. An electrochemical machining method for thin metal strips, which is executed by the electrochemical machining apparatus for thin metal strips of claim 1, wherein the electrochemical machining method for thin metal strips comprises:
S100, moving the upper fixture and the pressing part to an initial position and then keeping the upper fixture and the pressing part stationary;
S200, introducing an electrolyte into the electrolyte channel to fill the electrolyte channel, and then closing the electrolyte channel;
S300, connecting the positive electrode of the power supply to the thin strip material, and connecting the negative electrode of the power supply to the pressing part;
S400, starting the conveying mechanism, conveying the thin strip material into the machining area, conveying the thin strip material to pass through the machining area at a constant speed, wherein the power supply uses the electrolyte as a medium in the machining area to electrically connect the thin strip material and the pressing part, and the electrolyte and the thin strip material undergo an electrochemical reaction to complete removal and thinning of a surface of the thin strip material;
S500, after the thin strip material completes one cycle under conveyance of the conveying mechanism, turning off the power supply and the conveying mechanism, measuring the thickness of the thin strip material by the thickness gauge, and then driving the thin strip material to enter the input side of the machining area again, and adjusting a gap between a surface of the pressing part close to the machining area and a bottom surface of the groove in the vertical direction according to the thickness measured by the thickness gauge; and
S600, repeating S400 to S500, measuring the thickness of the thin strip material by the thickness gauge until the thickness of the thin strip material after moving out of the machining area reaches a target thickness, and turning off the electrochemical machining apparatus for thin metal strips.

9. The electrochemical machining method for thin metal strips according to claim 8, wherein the electrolyte comprises a sodium nitrate solution or a sodium chloride solution.

10. The electrochemical machining method for thin metal strips according to claim 9, wherein a concentration of the electrolyte is within a range of 5%-50%.

11. The electrochemical machining method for thin metal strips according to claim 9, wherein an inlet pressure of the electrolyte is within a range of 0.00 MPa-2.00 MPa.

12. The electrochemical machining method for thin metal strips according to claim 9, wherein a temperature of the electrolyte is within a range of 0°C-50°C.

13. The electrochemical machining method for thin metal strips according to claim 8, wherein in S300, a machining voltage of the power supply is within a range of 0 V-40 V.

14. The electrochemical machining method for thin metal strips according to claim 8, wherein a moving speed of the thin strip material is within a range of 1.00 mm/min-20.00 mm/min.
